(19) United States
(12) Patent Application Publication
(10) Pub. No.: US 2005/0012642 A1
(43) Pub. Date: Jan. 20, 2005

(54) Attitude indicator for an aircraft

(76) Inventor: Jérôme Sacle, Toulouse (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/483,828

(22) PCT Filed: Jan. 31, 2003
(86) PCT No.: PCT/FR03/00302

(30) Foreign Application Priority Data
Feb. 1, 2002 (FR) 02/01217

(51) Int. Cl. G01C 23/00

(52) U.S. Cl. 340/973

(57) ABSTRACT

This attitude indicator comprises a display device (11) with screen (110), producing on a screen background (4, 5), a three-dimensional aircraft silhouette (3), mobile according to the three axes of rotation and viewed from the rear, according to attitude angles which correspond to the attitude angle measurements received by onboard instruments and which are referenced with respect to an aircraft datum having a roll axis perpendicular to the surface of the screen and pitch and yaw axes in the plane of the screen, one, the pitch axis, being horizontal and the other, the yaw axis, vertical. It has the advantage of affording the crew a concrete view of the attitude of the aircraft enabling piloting to be rendered more natural and more intuitive, and hence safety to be improved.

The invention is concerned with instruments for piloting an aircraft and more particularly with the attitude indicator often referred to as the “artificial horizon” and designated by the acronym ADI standing for “Attitude Direction Indicator”.

The attitude indicator ADI is the most important piloting instrument in the event of poor visibility and in the instrument flight regime IFR. It serves chiefly to present the pilot of an aircraft with the attitude measurements performed by the equipment aboard the aircraft such as an AHRS (the acronym standing for “Attitude and Heading Reference System”) or an IRS inertial system (the acronym standing for “Inertial Reference System”). Subsidiary, it makes it possible to present other important flight parameters such as the barometric or radio altitude, the air speed, the sideslip, etc.

The presentation of the information of an ADI attitude indicator is done, pictorially, through the intermediary of a model aircraft which reproduces the attitude of the aircraft on a background symbolizing the sky, the earth and the horizon line.

The very great majority of ADI indicators display on their screen a fixed model aircraft on a movable background representing the sky and the earth that are separated by a so-called “artificial horizon” line, moving heightwise and inclination-wise.

The model aircraft may be a more or less detailed three-dimensional representation that goes as far as to show the positions of the flaps and of the landing gear of the aircraft as is described in European patent application EP 1 102 038.

With this mode of display with fixed model aircraft and movable artificial horizon, the transverse inclination of the artificial horizon corresponds to the opposite of the lateral inclination of the aircraft whereas the height of the artificial horizon within the screen corresponds to the opposite of the longitudinal inclination of the aircraft. Lateral angular scales complete the display so as to specify the angle of transverse inclination of the artificial horizon line. Furthermore, the height with respect to the screen of the artificial horizon line is translated into an angle of roll.

With the aid of these three displayed elements: ground zone and sky zone separated by a horizon line that can move angularly and height-wise on the screen, the pilot can assess the angles of pitch and roll of his aircraft as well as their evolution in the course of the maneuvers that he engages. Other important flight parameters are also displayed on the screen of an ADI attitude indicator, by inlaying numerals and small symbols such as the altitude or the height above the ground, the sideslip of the aircraft, its air speed, etc. However, they are limited in number since the reading of an artificial horizon screen must remain very intuitive.

This mode of display with fixed model aircraft and movable artificial horizon has the advantage, in the event of a head-up display, that is to say one which is superimposed on the canopy of the aircraft with the exterior panorama, of showing a horizon line and sky and ground zones that correspond to reality when the view is clear and that consequently enable the pilot to retain markers outside the aircraft even within a setting remote from that of fly-by-sight and hence to continue to consider the attitude of his aircraft with respect to an absolute datum tied to the ground. However, this advantage in fact becomes a drawback when the ADI attitude indicators have their display screens placed on the instrument panel. Indeed the pilot, who consults their screens, tends to take as position datum a datum tied to his aircraft since he no longer has access, in his field of view, to any markers originating from the panorama outside the aircraft.

The interpretation of the screens of the ADI attitude indicators with fixed model aircraft and movable background therefore lacks naturalness since the small surface area of these screens does not allow the exterior panorama to be simulated in a credible manner and forces the pilot to concentrate in order to come back to an absolute datum tied to the ground, this return being necessary so as to take account of the fact that the artificial horizon line reacts in the opposite sense to the pilot's action on the controls of the aircraft, the taking up by the aircraft of a leftward transverse inclination translating into a taking up by the artificial horizon line of a rightward inclination and the taking up by the aircraft of a nose-down inclination translating into the rising of the artificial horizon line.

There has also been proposed another mode of display with movable model aircraft on a background representing the sky and the earth that are separated by a fixed artificial horizon line, that is of more natural interpretation in respect of an instrument on the instrument panel. As an example, mention may be made of the ADI attitude indicator described in French patent application FP 2 009 543 which uses a mechanical display with a model aircraft movable heightwise and inclination-wise with respect to a fixed horizon line. Mention may also be made of the ADI attitude indicator described in French patent application FP 2 569 840 which uses a television tube display showing a model aircraft in three dimensions moving in front of an image background comprising a fixed horizon line and various orientation axes.

This mode of display with movable model aircraft, which is of more natural interpretation for a pilot having no outside markers, has the drawback of giving only a coarse indication of the height of the aircraft above the ground by reason of the relatively significant size of the model aircraft with respect to the screen which requires it to be kept in the vicinity of the center of the screen.

An aim of the present invention is to solve this problem by proposing an attitude indicator for aircraft with a display with movable model aircraft on a background artificial horizon remaining horizontal but moving heightwise in the screen in such a way as to give the pilot a better appreciation of the height of the aircraft above the ground in particular in the landing or take off phase.

More generally, the aim thereof is an attitude indicator for aircraft with a display giving the crew information on the flight attitude and the configuration of the aircraft in a concentrated and very intuitive form requiring only a minimum of interpretation.

Its subject is an aircraft attitude indicator receiving, from equipment aboard the aircraft, information on the aircraft flight conditions, including: measurements of the roll, pitch and yaw attitude angles of said aircraft with respect to a ground datum, and comprising a display device producing on a screen, an image representing, on a screen background, a three-dimensional aircraft silhouette, the screen background being split into two zones: a lower zone symbolizing the ground and an upper zone symbolizing the sky which are separated by a horizontal boundary line symbolizing the horizon line, and the aircraft silhouette being mobile according to the three axes of rotation and viewed from the rear, according to attitude angles which correspond to the attitude angle measurements received and which are referenced with respect to an aircraft datum having a roll axis perpendicular to the surface of the screen and pitch and yaw axes in the plane of the screen, one, the pitch axis, being horizontal and the other, the yaw axis, vertical, remarkable in that the horizon line displayed moves heightwise over the screen as a function of the height of the aircraft with respect to the ground, as measured by the equipment aboard the aircraft.

Advantageously, the display device produces, on a screen background, an aircraft 3D silhouette exhibiting a difference of hue between its belly and its back so as to differentiate the nose-up attitudes from the nose-down attitudes.

Advantageously, the display device produces, on a screen background, an aircraft 3D silhouette resembling the type of aircraft, for which the attitude indicator of which it forms part is intended.

Advantageously, the screen background upper zone symbolizing the sky is blue in color.

Advantageously, the screen background lower zone symbolizing the ground is brown in color.

Advantageously, the screen background lower zone symbolizing the ground is green in color.

Advantageously, the display device produces an image representing, on a screen background, an aircraft 3D silhouette comprising parts changing aspect as a function of the momentary state of the corresponding part of the aircraft.

Advantageously, the parts of the aircraft 3D silhouette changing aspect comprise movable elements depicting movable aerodynamic planes of the aircraft equipped with the attitude indicator, placed in positions corresponding to position indications provided by equipment aboard the aircraft.

Advantageously, the parts of the air(craft 3D silhouette changing aspect comprise movable elements depicting the flaps of the aircraft equipped with the attitude indicator, placed in positions corresponding to flap position indications provided by equipment aboard the aircraft.

Advantageously, the movable elements depicting the flaps of the aircraft equipped with the attitude indicator are bar scales exhibiting as many bars as flap notches extended.

Advantageously, the parts of the aircraft 3D silhouette changing aspect comprise movable elements depicting the airbrakes or spoilers of the aircraft equipped with the attitude indicator, placed in positions corresponding to airbrake position indications provided by equipment aboard the aircraft.

Advantageously, the movable elements depicting the airbrakes of the aircraft equipped with the attitude indicator are bar scales exhibiting as many bars as airbrake/spoiler notches extended.

Advantageously, the parts of the aircraft 3D silhouette changing aspect comprise movable elements depicting the landing gear of the aircraft equipped with the attitude indicator, placed in positions corresponding to landing gear position indications provided by equipment aboard the aircraft.

Advantageously, the display device produces on a screen background an aircraft 3D semitransparent silhouette revealing movable elements that are normally out of sight.

Advantageously, the display device produces on a screen background, in addition to an aircraft 3D silhouette, alignment symbols corresponding to attitude presets for the aircraft.

Advantageously, the display device produces an image representing, on a screen background, in addition to an aircraft 3D silhouette, an alignment symbol of circular shape, with the diameter of the aircraft 3D silhouette, and into which the pilot must inlay the fuselage or the tail of the aircraft 3D silhouette so as to comply with the corresponding attitude preset.

Advantageously, the display device produces an image representing, on a screen background, in addition to an aircraft 3D silhouette, an alignment symbol in the shape of an arc of a circle with the concavity pointing toward the nose of the aircraft 3D silhouette, into which the pilot must bring the nose of the aircraft 3D silhouette so as to comply with the corresponding attitude preset.

Advantageously, the display device produces an image representing, on a screen background, in addition to an aircraft 3D silhouette, an alignment symbol in the form of two strokes against which the pilot must bring the leading edge of the wings of the aircraft 3D silhouette so as to comply with the corresponding attitude preset.

Advantageously, the display device produces an image representing, on a screen background, an aircraft 3D silhouette with leading edges whose aspects differ as a function of the extent of the icing noted by equipment aboard the aircraft.

Advantageously, the display device produces an image representing, on a screen background, an aircraft 3D silhouette with leading edges having contours enhanced and overlaid as a function of the extent of the deposition of ice noted by equipment aboard the aircraft.

Advantageously, the display device produces an image representing, on a screen background, an aircraft 3D silhouette with engines whose aspects differ as a function of their operating states.

Advantageously, the display device produces an image representing, on a screen background, an aircraft 3D silhouette with engines struck through with a cross and/or colored yellow or amber in case of loss of power noted by equipment aboard the aircraft.

Advantageously, the display device produces an image representing, on a screen background, an aircraft 3D silhouette with engines followed by a plume and/or colored red in case of detection of fire made by equipment aboard the aircraft.

Advantageously, the display device produces an image representing, on a screen background, an aircraft 3D silhouette and numeral inlays corresponding to values of flight parameters.

Advantageously, the display device produces an image representing, on a screen background, an aircraft 3D silhouette and numeral inlays corresponding to the height of the aircraft above the ground as measured by equipment of the aircraft.

Advantageously, when the display device produces an image representing, on a screen background, an aircraft 3D silhouette with numeral inlays corresponding to the height of the aircraft above the ground as measured by equipment of the aircraft, it vertically enframes these inlays with two elevation arrows showing that a measurement of vertical distance with respect to the ground is involved.

Advantageously, when the display device produces an image representing, on a screen background, in addition to an aircraft 3D silhouette, an alignment symbol corresponding to an attitude preset for the aircraft, it also produces two numeral inlays, one corresponding to the angle of pitch corresponding to the attitude preset and the other to the measured angle of pitch.

Advantageously, the display device produces, at the image lateral borders, lateral scales graduated in terms of angle of pitch and movable markers moving opposite same indicating the graduation value of the pitch scales corresponding to the pitch angle measurement provided by the equipment aboard the aircraft.

Advantageously the display device produces, at the image upper border, a scale graduated in terms of angle of roll and a movable marker moving opposite same indicating the graduation value of the roll scale corresponding to the roll angle measurement provided by the equipment aboard the aircraft.

Other advantages and characteristics of the invention will emerge from the description hereinbelow of an embodiment given by way of example. This description will be offered in conjunction with the drawing in which:

FIG. 1 is a diagrammatic representation of an ADI attitude indicator in accordance with the invention, and

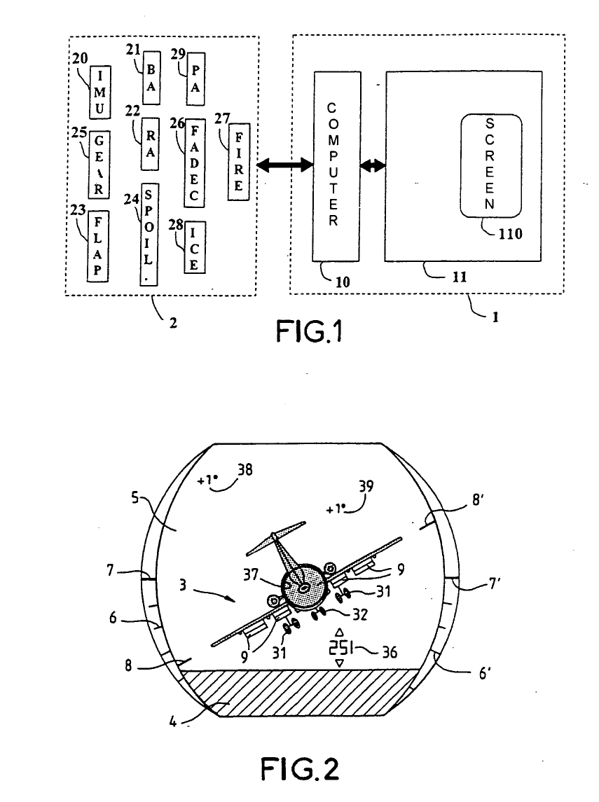

FIGS. 2 to 12 are illustrations of the images produced by devices for displaying an ADI artificial horizon in accordance with the invention in various flight situations.

As shown in FIG. 1, an ADI attitude indicator 1 also referred to as an artificial horizon comprises, in a general manner, a data utilization circuit 10 controlling a display device 11 equipped with a screen 110. The data utilization circuit 10, which is computer based, receives various items of information from the navigation equipment 2 on board the aircraft. It utilizes this information to glean therefrom one or more sets of measurements of the various angles of attitude of the aircraft with respect to a ground datum if these measurements do not already appear explicitly in the information originating from the navigation equipment 2 of the aircraft as may be the case for the information provided by an IMU inertial system 20 (the acronym standing for “Inertial Measurement Unit”). In the event that several sets of measurements of attitude angles that are complete or incomplete are available, it combines them so as to extract therefrom a complete set of measurements of attitude angles which is as reliable as possible. It transmits the complete set adopted of measurements of attitude angles as well as of other flight parameters originating from other on-board navigation equipment, such as measurements of altitude or of height above the ground as delivered by a barometric altimeter BA 21 or a radio probe RA 22, positions of flaps, of airbrakes/spoilers, of landing gear delivered by position sensors 23, 24, 25, lack of engine thrust alarms delivered by an FADEC engine monitoring device 26 (the acronym standing for “Full Authority Digital Engine Controllers”), alarms of engine fire delivered by a fire detection device 27, an icing alarm delivered by an ice detector 28 or attitude presets given by an automatic pilot 29, to the display device 11 so that the latter posts them on its screen 110 in a visual form that can be easily assimilated by the pilot.

As represented in FIGS. 2 to 11, the display device 11, instead of presenting the customary model airplane consisting of two immobile horizontal strokes or of an immobile dot at the centre of its screen, displays on its screen 110 a three-dimensional silhouette of the aircraft viewed from the rear, in an attitude corresponding to that at present, that is to say with a roll angle corresponding to that measured by the onboard instruments, shown with respect to a roll reference axis placed perpendicularly to the plane of the screen, with a pitch angle corresponding to that measured by the onboard instruments, shown with respect to a pitch reference axis placed horizontally in the plane of the screen and with a yaw angle corresponding to that measured by the onboard instruments, shown with respect to a yaw reference axis placed vertically in the plane of the screen.

This aircraft 3D silhouette, which remains at the centre of the screen while being able to move in rotation about the three axes of roll, pitch and yaw, is embellished with movable elements depicting the movable aerodynamic planes of the aircraft: flaps, airbrakes/spoilers, as well as its landing gear, in their positions at present, extended or retracted, noted by the onboard equipment. It is furthermore accompanied by simple (visually speaking) symbols corresponding either to critical flight data such as icing, an engine failure or an engine fire, or to attitude presets. It is presented on a 2D screen background split horizontally into two zones: a lower zone symbolizing the ground and an upper zone symbolizing the sky, separated by a boundary line symbolizing the horizon line.

The movable elements of the aircraft 3D silhouette depicting the flaps of the aircraft and the airbrakes/spoilers consist of scales that are attached, on the aircraft 3D silhouette, to the approximate locations of the flaps and airbrakes/spoilers, and deployed to a greater or lesser degree as a function of the positions, more or less extended, of these flaps and airbrakes/spoilers. Each scale representing a flap or an airbrake/spoiler portrays a number of bars corresponding to the number of notches extended. In the figures showing various flight situations, one can see up to four flap notches extended and two airbrake/spoiler notches.

The phenomenon of icing is brought to the attention of the pilot by an enhancing of the contours or a modifying of the color of the leading edges of the wings that is all the more pronounced the greater the icing. The phenomenon of power loss of an engine is signaled by a cross overlying the engine in question or by a modification of color of the engine in question such as a switch to yellow or amber so as to signal its unavailability. An engine fire is signaled by a stylized plume of smoke issuing from the engine in question, possibly supplemented by a modification of color of the engine in question such as a switch to red.

When, in certain attitudes of the aircraft, elements of the landing gear are not directly visible on the aircraft 3D silhouette displayed on the screen, they are nevertheless shown in see-through mode so that the pilot has at any instant an accurate idea of their positions.

The attitude presets are portrayed on the screen, by alignment symbols consisting either in cases where the pitch angle is zero or small, of a circle into which the pilot must inlay the fuselage or the tail of the aircraft 3D silhouette, or in cases where the pitch angle is bigger, of an arc of a circle with the concavity pointing toward the nose of the aircraft 3D silhouette, into which the pilot must inlay the nose of the aircraft 3D silhouette. Each time there is an attitude preset to be complied with, the value of this preset is recorded in digital by an inlay of numerals in the left part of the screen while the actual measured value is given by an inlay of numerals in the right part of the screen.

As a variant, the alignment symbols may also comprise two strokes against which the pilot must bring the leading edge of the wings of the aircraft 3D silhouette.

The screen background zone symbolizing the ground always remains at the bottom of the screen, underneath the screen background zone symbolizing the sky. It is separated therefrom by a boundary line running transversely across the screen, supposedly recalling the horizon line. This line which always remains visible on the screen, moves height-wise over the screen, as a function of the height of the aircraft above the ground as measured by onboard equipment. It reaches the wheels of the landing gear of the aircraft 3D silhouette when the aircraft touches the ground so as to enhance the realism of the representation.

Since the distance separating the aircraft 3D silhouette from the screen background line symbolizing the horizon line gives only a very vague indication of the height of the aircraft above the ground, it can be specified by a digital inlay between two elevation arrows, one pointing toward the horizon line and the other toward the aircraft 3D silhouette.

The angle of roll of the aircraft which is pretty much akin to the inclination of the wings of the aircraft 3D silhouette on the screen may be specified by means of two angular scales drawn at the periphery of the screen and of two pointers facing these angular scales, directly in line with the tips of the wings of the aircraft 3D silhouette.

The angle of pitch of the aircraft may be indicated by numerical values inlaid into the image or by virtue of angle of pitch scales placed on the lateral borders of the image and of movable markers moving opposite same. In the case of pitch angle lateral scales, it is possible to add a roll angle scale at the upper border of the image with a movable marker moving opposite same.

For better visibility, the two zones of the screen background symbolizing the sky and the ground, the aircraft 3D silhouette ventral and dorsal parts, the movable elements of this latter and the various symbols inlaid on the screen are presented in specific colors easing their identifications. The screen background zone symbolizing the ground is for example plain brown in color, verging toward greenish yellow or plain green, the screen background zone symbolizing the sky plain sky blue in color, the aircraft 3D silhouette two plain grey colors, the darker for the ventral part and the lighter for the dorsal part, the flap scales white in color with emboldened bars, the airbrake/spoiler scales in two-tone chequerboard, the alignment and attitude preset symbols originating from the automatic pilot/flight director, pink, magenta or green in color, the critical alarm information red in color, and the numerical symbols corresponding to measured data colored either black on a sky background, or white on a ground background, in such a way as to always stand out clearly. The upper and lateral auxiliary scales may be colored black on a white background or colored white on a black background.

By virtue of this representation, the ADI attitude indicator just described affords the crew a very intuitive picture of the attitude of the aircraft with moreover a certain amount of important flight information including the position of the flaps, those of the landing gear, that of the airbrakes/spoilers and the state of the engines. The advantage for the pilot is that of knowing the configuration of his aircraft while focusing on the main piloting instrument constituted by the ADI attitude indicator. During an interrupted approach, the additional stress and workload tend to engender piloting errors such as omitting to retract the flaps or the landing gear, possibly leading to an endangering of the safety of the flight on the basis of a simple overshoot. With this design appearing on the screen of the attitude indicator, in the event that manual control of the aircraft is re-exercised, the crew displaying the overshoot trim, will become instantly aware of the configuration of the aircraft and will quickly remedy any omission or error of configuration made in the initial haste. The proposed design affords great security.

With the customary designs of ADI attitude indicators of the prior art, the pilot has to look away from the ADI attitude indicator which is his main piloting instrument in order to search for the information regarding the position of the flaps via the corresponding indicator of the instrument panel or console, then thereafter the information regarding positions of the landing gear as given by another indicator of the instrument panel or console, then possibly the information regarding the position of the airbrakes/spoilers given by yet another indicator of the instrument panel or console, and subsequently, mentally marshal all of this different information so as to deduce therefrom the actual configuration of the aircraft. Within the framework of the design proposed, the configuration of the aircraft is presented in the pilot's primary field of view at all times, including particularly those when the crew must quickly acquire overall information about the configuration of the aircraft.

The aircraft 3D silhouette shown on the screen of the ADI attitude indicator is lifelike in the sense that it reacts in a natural manner to the pilot's handling of the controls of the aircraft. There is no longer any interpretation of the kind: “The ground is tilting to the left, hence the aircraft is turning right”. This is a move toward natural piloting replacing interpretation of geometrical shapes to determine the attitude of the aircraft in space.

The sideslip indicator is replaced by the sideslip of the aircraft 3D silhouette viewed from the rear. The sideslip is proportional to the magnitude of the depicted lateral part of the aircraft (fuselage and fin), thereby giving as accurate an indication as the contemporary onboard instruments that do not display parameters quantifying the sideslip but only a proportionality (deviation of a ball from its rest position in earlier onboard instruments).

The aircraft 3D silhouette shown on the screen of the ADI attitude indicator is chosen to resemble the aircraft equipped with the ADI attitude indicator. In FIGS. 2 to 11, it resembles a Mac Donnell Douglas series 80 but it is of course understood that with another type of aircraft, it will have a different appearance. For example with an airbus A380, it will have the form of this machine with its flaps, airbrakes/spoilers, landing gear and engines positioned in a representative manner. The advantage of this resemblance of the aircraft 3D silhouette with the aircraft actually equipped with the ADI attitude indicator is that it enables the crew to be supplied, in their primary field of view, with information regarding icing, engine failure or engine fire with the aid of simple symbolization: enhancing of the contour of the leading edges of the wings by red highlighting, marking of an engine with a red cross, a change of color and/or a flame escape symbolized by red trails.

At present, the determination of a defective engine is performed by consulting indicators of the engine parameters and then by interpreting these indicators. Interpretation takes more time for four-engine planes. The new design of the screen of the ADI attitude indicator entails direct information capture without interpretation followed, only later, by confirmation at the level of the indicators of the engines. Fast and representative awareness of the defective engine has just as beneficial a repercussion in the saving of time to identify and deal with the engine defect in a stressful environment, giving rise to an overload of work. Many situations have worsened following actions undertaken in error visàvis normally operating engines. The choice adopted of presenting this engine information at the level of the ADI attitude indicator is motivated by the search for improved safety.

By virtue of the realism of the aircraft 3D silhouette, it has been possible to supplement the customary attitude information of an ADI attitude indicator with the information regarding the positions of the flaps, of the airbrakes/spoilers, of the landing gear, engine failure and fire, and icing, doing so without any particular overload since this information conditions the exterior aspect of the aircraft. The simplicity of this representation allows the addition of other information likewise useful for piloting such as the height above the ground as measured by radio probe. The latter is presented both through an effect of approaching or receding of the ground with respect to the aircraft, up to landing where the latter makes contact with the ground and through a digital value displayed between two elevation arrows. The gain, as regards safety, of the representation of the ground approaching is the pilot's more vivid awareness of the concept of proximity, as compared with merely reading the digital value of the radio probe height.

The screen background zone symbolizing the ground is always kept visible at least by a residual band at the bottom of the screen. When the distance of the aircraft with respect to the ground is considerable, in practice when it is out of radio altimeter range, the residual band symbolizing the ground at the bottom of the screen remains a constant distance from the aircraft 3D silhouette and the digital value giving the ground height of the aircraft is deleted from the display. The digital display of the height of the aircraft above the ground only in cases of relatively small values makes it possible, through its sudden appearance on the screen of the attitude indicator, to alert the pilot of the proximity of the ground.

The presentation of the information regarding icing at the level of the screen of the ADI artificial horizon through a red colored highlighting on the wings or the leading edges of the wings according to the attitude of the aircraft, is motivated by the danger to which icing gives rise within the framework of instrument-based flight where freezing conditions are regularly encountered. The danger of a worsening icing situation is then communicated directly into the primary field of the pilot who obtains a concrete visual representation of the aircraft laden with ice that he feels at the controls, involving precautions appropriate for piloting. This aspect is beneficial for safety.

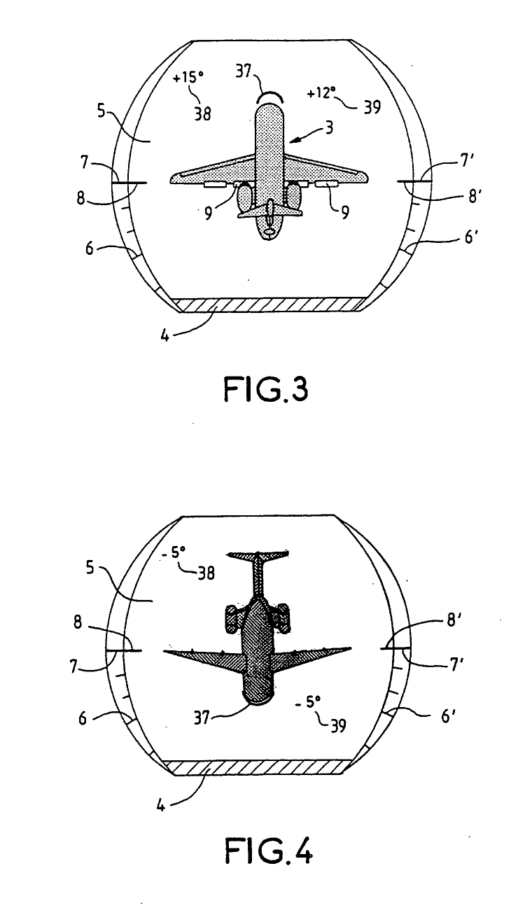

With the designs of the ADI attitude indicators of the prior art, the symbolization of the flight director which is the attitude preset given by the automatic pilot, is simple since the aircraft is represented by a model airplane having the form of a dot or of a pair of immobile horizontal strokes. It often has the form of a cross on which the pilot must align the model airplane for his aircraft to be in the ideal position. In the case of the proposed ADI attitude indicators displaying an aircraft 3D silhouette, the symbolization of the flight director is more complicated. It may take two distinct forms according to the magnitude of the aircraft's pitch angle. If the aircraft's pitch angle is zero or small and if this aircraft has a cylindrical fuselage (FIGS. 2, 5, 6, 10, 11) the flight director is symbolized by a circle with the approximate diameter of the fuselage into which the pilot must inlay the aircraft in order to follow the preset. If the aircraft's nose-up or nose-down pitch angle is not negligible and if this aircraft has a cylindrical fuselage, (FIGS. 3, 4, 7, 8, 9), the flight director is symbolized by an arc of a circle with concavity pointing toward the nose of the aircraft and whose radius of curvature can alter and into which the pilot must inlay the nose of the aircraft in order to follow the preset. The change of form of the flight director from circle to arc of a circle or vice versa does not present a considerable discontinuity in the change of marker to be followed, an arc of a circle being a part of a circle.

These symboligies allow display of the flight director that alters as a function of the deviation with respect to the preset or to the piloting law to be followed. For deviations in roll, the flight director in the form of a circle or arc of a circle moves toward the side where the turn has to be accentuated or loosened. In case of sideslip, whatever the pitch angle of the aircraft, the pilot must continue to make the form of the aircraft coincide with the symbol of the flight director.

The symbolization of the flight director may also take the form of two strokes against which the pilot must bring the leading the edge of the wings of the aircraft so as to follow the preset.

FIGS. 2 to 12 give examples of the display appearing on the screen of an ADI attitude indicator in various flight configurations. The same indexations are used throughout these figures. The numeral 3 marks the aircraft 3D silhouette. The numeral 4 marks the screen background zone, which is hatched, symbolizing the ground. The numeral 5 marks the screen background zone symbolizing the sky, which is distinguished from the screen background zone symbolizing the ground by an absence of hatching. The numerals 6 and 6′ mark the lateral scales of angle of roll inclination. The numerals 7 and 7′ index the zero-inclination marks on the lateral scales of angle of roll inclination 6 and 6′. The numerals 8 and 8′ mark the mobile indices placed directly in line with the wings of the aircraft 3D silhouette and that face the roll inclination angle lateral scales. The numeral 9 marks the scales depicting the flaps. The number 30 marks the scales depicting the airbrakes/spoilers. The number 31 marks the central landing gear. The number 32 marks the front landing gear. The number 33 marks the highlighting of icing. The number 34 marks the crosses signaling a loss of engine power. The number 35 marks the engine fire plume. The number 36 marks the digital value of the height above the ground, enframed by its two elevation arrows. The number 37 marks the flight director. The number 38 marks the digital value of pitch angle preset corresponding to the flight director. The number 39 marks the digital value corresponding to the pitch angle measured by onboard equipment.

More precisely, FIG. 2 shows the display appearing on the screen of the ADI attitude indicator when the aircraft is turning, in approach/landing configuration. The aircraft is turning to the left, inclined at around 35 degrees, the roll inclination lateral scale 6, 6′ being read on the side of the low wing with the aid of the mobile index 8, for example by graduations of 10 degrees from the zero-inclination mark 7. The pitch angle is +1 degree and is displayed in digital form 39 on the right side of the aircraft 3D silhouette 3. This digital display replaces the customary pitch scale. The deleting of the pitch scale is motivated by the non-linearity of this scale and good comprehension for the pilot, of the pitch angle from the aircraft 3D silhouette 3. The sideslip angle is zero since the aircraft 3D silhouette 3 viewed from behind is symmetric with respect to its longitudinal axis. The flight director 37 is represented by a circle on which the aircraft is centered, showing that the preset of the automatic pilot is complied with, this being corroborated by the fact that the digital values of the preset 38 and of the measurement 39 of the pitch angle are identical.

In addition to the attitude angles, the aircraft 3D silhouette 3 reveals that the landing gear 31, 32 are extended and that two flap segments 9 are extended.

The ground 4 is approaching. The numerical indication 36 of the altimetric probe indicates a height above the ground of 251 feet.

FIG. 3 shows the display appearing on the screen of the ADI attitude indicator when the aircraft is in the initial climb after takeoff.

The aircraft is flying at zero inclination. The mobile indices of inclination 8 and 8′ are directly in line with the zero-inclination marks 7 and 7′. The pitch angle is +12 degrees and is displayed in digital form 39 on the right side of the aircraft 3D silhouette 3.

The sideslip angle is zero since the aircraft 3D silhouette 3 viewed from behind is symmetric with respect to its longitudinal axis. The flight director 37 is represented by an arc of a circle since the nose-up pitch angle is significant. To inlay the nose of the aircraft 3D silhouette 3 into the arc of the circle of the flight director 37, the pilot must again lift the nose of the aircraft more so as to increase the pitch angle from the measured angle of +12 degrees displayed at 39 in digital form to the preset value of +15 degrees displayed at 38 in digital form.

The aircraft 3D silhouette 3 reveals that the landing gear 31, 32 are retracted since they are not visible and that a flap segment 9 is extended.

The ground 4 is at its lower limit. The absence of numerical indication 36 of altimetric probe shows that the height above the ground exceeds the radio altimeter range.

FIG. 4 shows the display appearing on the screen of the ADI attitude indicator when the aircraft is in the initial descent.

The aircraft is flying at zero inclination. The mobile indices of inclination 8 and 8′ are directly in line with the zero-inclination marks 7 and 7′. The pitch angle is −5 degrees and is displayed in digital form 39 on the right side of the aircraft 3D silhouette 3. For a nose-down angle, the digital display 39 of the measured value of pitch angle passes into the lower part of the screen so as to continue to display this value alongside the nose of the aircraft. The aircraft 3D silhouette presents its belly whereas it presented its back in the previous figure since the attitude has gone from nose-up to nose-down. For better differentiation of the climbing or descending attitudes of the aircraft, the aircraft 3D silhouette presents a darker lower face than upper face. The sideslip angle is zero since the aircraft 3D silhouette 3 viewed from behind is symmetric with respect to its longitudinal axis. The flight director 37 is represented by an arc of a circle since the nose-down pitch angle is significant. The pilot has correctly displayed a nose-down trim so as to follow the preset of the flight director since the nose of the aircraft 3D silhouette 3 is inlaid into the arc of the circle of the flight director 37. The preset value of −5 degrees of the pitch angle remains displayed at 38 in digital form at the top left of the screen.

The aircraft 3D silhouette 3 reveals that the landing gear 31, 32 and the flaps are retracted since they are not visible.

The ground 4 is at its lower limit. The absence of altimetric probe numerical indication 36 shows that the height above the ground exceeds the radio altimeter range.

FIG. 5 shows the display appearing on the screen of the ADI attitude indicator when the aircraft is carrying out a non-symmetric cruising flight.

The aircraft is flying at zero inclination. The mobile indices of inclination 8 and 8′ are directly in line with the zero-inclination marks 7 and 7′. The pitch angle is zero degrees. The sideslip angle is significant since the aircraft 3D silhouette 3 viewed from behind has its nose appreciably shifted to the left and shows the left lateral part of its fuselage and of its fin. The flight director 37 is represented by a circle since the pitch angle is zero. The aircraft complies with the preset of the flight director since the tail of the aircraft 3D silhouette 3 is inlaid into the circle of the flight director 37. The preset value of zero degrees of the pitch angle remains displayed at 38 in digital form at the top left of the screen while the measured value of zero degrees for the pitch angle is displayed at 39 at the top of the right part of the screen.

The aircraft 3D silhouette 3 reveals that the landing gear 31, 32 are retracted since they are not visible and that no flap segment 9 is extended.

The ground 4 is at its lower limit. The absence of altimetric probe numerical indication 36 shows that the height above the ground exceeds the radio altimeter range.

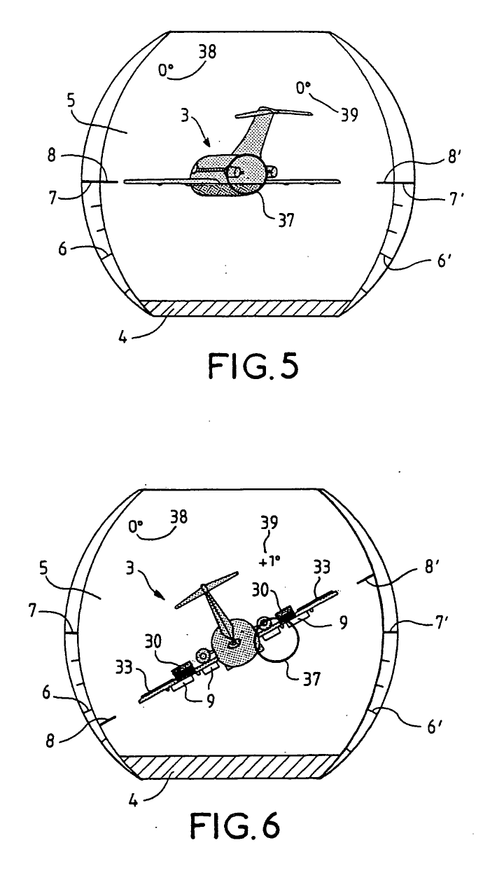

FIG. 6 shows the display appearing on the screen of the ADI attitude indicator when the aircraft is turning, at the start of an approach.

The aircraft is turning to the left, inclined at around 35 degrees. The pitch angle is +1 degree. The sideslip angle is zero since the aircraft 3D silhouette 3 is viewed symmetrically from behind. The flight director 37 is represented by a circle since the nose-up pitch angle is small. The pitch value of the preset of the flight director is zero degrees. The pilot must loosen the turn without changing the pitch angle so as to bring the circle of the flight director 39 back onto the fuselage of the aircraft 3D silhouette. The preset value of zero degrees of the pitch angle is displayed at 38 in digital form at the top left of the screen, while the measured value of +1 degree for the pitch angle is displayed at 39 at the top of the right part of the screen.

The aircraft 3D silhouette 3 reveals that the landing gear 31, 32 are retracted since they are not visible and that a flap segment 9 and two airbrake/spoiler segments are extended.

The ground 4 is at its lower limit. The absence of altimetric probe numerical indication 36 shows that the height above the ground exceeds the radio altimeter range.

A warning of icing 33 is depicted highlighted on the tips of the wings.

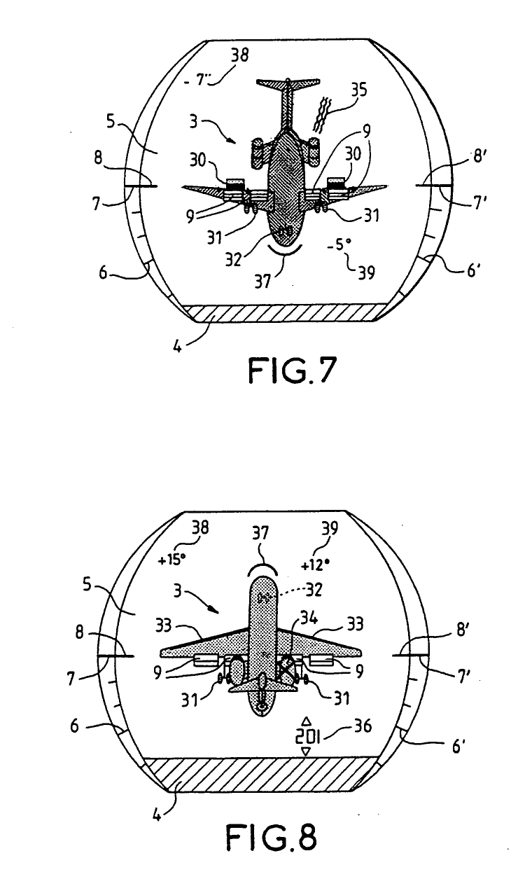

FIG. 7 shows the display appearing on the screen of the ADI attitude indicator when the aircraft is in its final approach on a steep slope.

The aircraft is flying at zero inclination with a pitch angle of −5 degrees displayed in digital form 39 on the right side of the aircraft 3D silhouette 3 alongside the nose. The sideslip angle is zero since the aircraft 3D silhouette 3 is viewed symmetrically from behind. The flight director 37 is represented by an arc of a circle, the nose-down pitch angle being significant. The pitch value of the flight director preset displayed in digital form at 38 at the top left of the screen is −7 degrees. The pilot must pitch the front of the plane down so that the nose of the aircraft 3D silhouette 3 becomes inlaid into the arc of the circle of the flight director 37 and so that its pitch angle goes from −5 degrees displayed in digital form at 39, at the bottom right of the screen, to −7 degrees.

The aircraft 3D silhouette 3 reveals that the landing gear 31, 32 are extended as are three flap notches 9 and two airbrakes/spoiler notches 30.

The ground 4 is at its lower limit on the screen. The absence of altimetric probe numerical indication 36 shows that the height above the ground exceeds the radio altimeter range.

Smoke symbolized by a fan of lines 35 issuing from the right engine signals a fire on this engine. This smoke may be accompanied by a red coloration of the right engine so as to make the problem affecting this engine yet more visible.

FIG. 8 shows the display appearing on the screen of the ADI attitude indicator when the aircraft is in the initial climb after an interrupted approach.

The inclination is zero. The pitch angle is +12 degrees and is displayed in digital form 39 on the right side of the aircraft 3D silhouette. The sideslip angle is zero since the aircraft 3D silhouette 3 is viewed symmetrically from behind. The flight director 37 is represented by an arc of a circle, the nose-up pitch angle being significant. The flight director preset value displayed in digital form at 38 in the top left of the screen is +15 degrees. To inlay the nose of the aircraft 3D silhouette 3 into the arc of the circle of the flight director 37, the pilot must pull the nose of the aircraft up more, the consequence of this being to increase the pitch angle from the measured value of +12 degrees displayed at 39 in digital form to the preset value of +15 degrees displayed at 38 in digital form.

The aircraft 3D silhouette 3 reveals that the landing gear 31, 32 are extended as are two flap notches 9. The front landing gear normally hidden in this view is shown in see-through mode so as not to lose its position information.

The ground 4 is close, above its lower limit on the screen. The numerical indication 36 of the altimetric probe indicates a height above the ground of 201 feet.

A warning of icing 33 is depicted highlighted on the tips of the wings. A cross 34 overlying the right engine tells of a loss of power of the right engine. As a variant, the loss of power of the right engine may be signaled by a coloration of this engine in yellow or amber instead of or in addition to the cross overlying it.

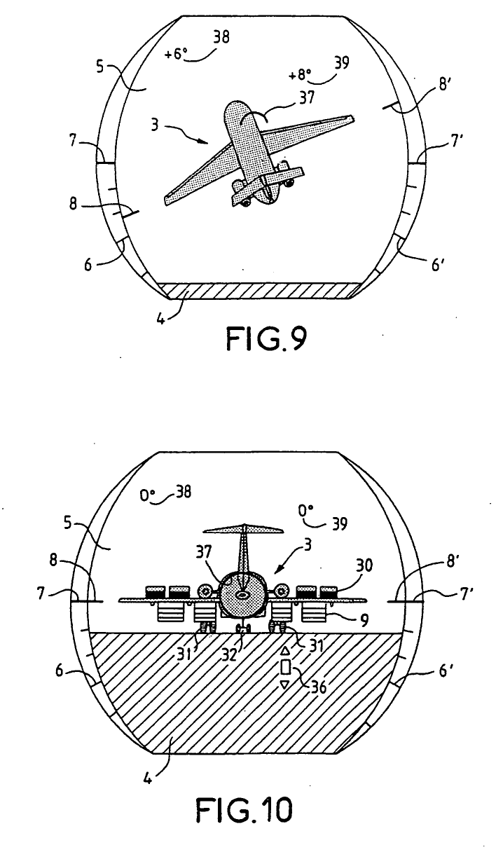

FIG. 9 shows the display appearing on the screen of the ADI attitude indicator when the aircraft is climbing.

The aircraft is turning to the left, inclined at around 22 degrees. The pitch angle is +8 degrees. The sideslip angle is zero since the aircraft 3D silhouette 3 is viewed symmetrically from behind. The flight director 37 is represented by an arc of a circle, the nose-up pitch angle being significant. The pitch value of the preset of the flight director is +6 degrees. The pilot must limit the nose-up by displaying a nose-up angle of +6 degrees and by reducing the inclination, the flight director 37 appearing on the right of the aircraft 3D silhouette 3. The preset value of +6 degrees of the pitch angle is displayed at 38 in digital form at the top left of the screen while the measured value of +8 degrees for the pitch angle is displayed at 39 at the top of the right part of the screen.

The aircraft 3D silhouette 3 reveals that the landing gear and the flaps are retracted since they are not visible.

The ground 4 is at its lower limit. The absence of altimeter probe numerical indication 36 shows that the height above the ground exceeds the radio altimeter range.

FIG. 10 shows the display appearing on the screen of the ADI attitude indicator when the aircraft is in the landing phase, standing on the runway.

The inclination of the aircraft is zero as are its pitch and sideslip angles. The flight director 37 is represented by a circle since the pitch angle is small. The pitch value of its preset is zero degrees. It is centered on the fuselage of the aircraft 3D silhouette 3. The preset value of zero degrees of the pitch angle is displayed at 38 in digital form at the top left of the screen while the measured value of zero degrees for the pitch angle is displayed at 39 at the top of the right part of the screen.

The aircraft 3D silhouette 3 reveals that the landing gear 31, 32 are extended as are four flap notches 9 and two airbrake/spoiler notches 30.

The ground 4 is at its upper limit on the screen and is touching the wheels of the landing gear. The numerical indication 36 of the altimetric probe indicates a height above the ground of zero feet.

This FIG. 10 shows that the proposed design makes it easier to follow landing, this being particularly worthwhile for category 3 landings.

FIG. 11 shows the display appearing on the screen of the ADI attitude indicator in the event of flying upside down.

The inclination and the pitch and sideslip angles are zero. The flight director 37 is represented by a circle, the pitch angle being small. The pitch value of the preset of the flight director is +2 degrees at zero inclination. The pilot must push on the stick (inverse controls) to bring the circle of the flight director 37 back onto the fuselage of the aircraft 3D silhouette 3 and display an (inverse) pitch angle of +2 degrees. The preset value of +2 degrees of the pitch angle is displayed at 38 in digital form at the top left of the screen, while the measured value of zero degrees for the pitch angle is displayed at 39 at the top of the right part of the screen.

The aircraft 3D silhouette 3 reveals that the landing gear, the flaps and the airbrakes/spoilers are retracted since they are not visible.

The ground 4 is at its lower limit. The absence of altimetric probe numerical indication 36 shows that the height above the ground exceeds the radio altimeter range.

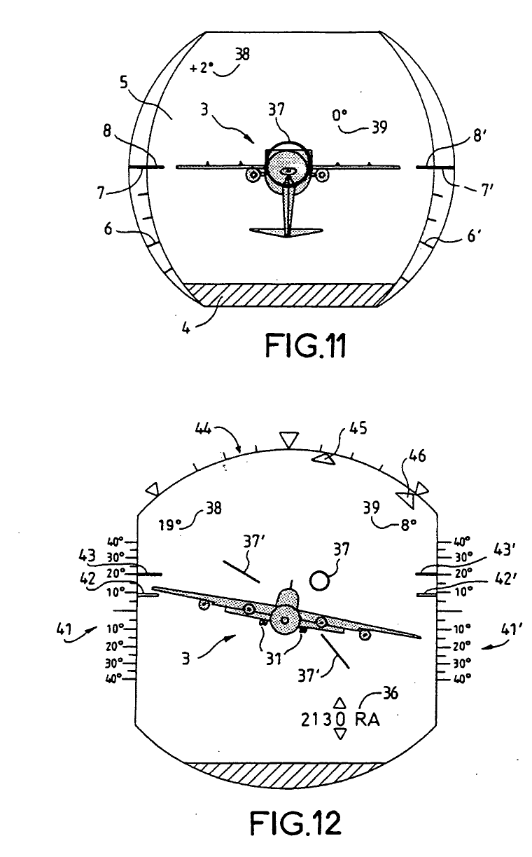

FIG. 12 shows a display variant for screen of an ADI attitude indicator. In this variant, the aircraft 3D silhouette 3 is that of a four-engine jet. The aircraft is climbing slightly with a positive pitch angle of +8° and turning very slightly to the right with a roll angle of around +10° to the right. Its sideslip angle is small since the aircraft silhouette 3 is almost seen symmetrically from the rear. The flight director is represented by a circle 37 in which the pilot must inlay the nose of the aircraft and two strokes 37′ against which the pilot must bring the leading edge of the wings of the 3D silhouette. The preset value of +19° of the pitch angle is displayed at 38 in numerical form at the top left of the screen while the measured value of +8° for the pitch angle is displayed at 39 at the top of the right part of the screen.

In contradistinction to FIGS. 2 to 11, the image displayed no longer exhibits any lateral scales of angle of roll inclination but lateral scales 41, 41′ of angle of pitch inclination with a first pair of movable indices 42, 42′ marking the measured value of the angle of pitch of the aircraft and a second pair of movable indices 43, 43′ marking the preset value of the angle of pitch. The lateral scales of roll inclination are merged into a single scale 44 transferred to the upper border of the image and cooperating with two movable indices, one 45 marking the measured value of the angle of roll and the other 46 the preset value of the angle of roll.

The aircraft 3D silhouette portrays the fact that the landing gear 31 is extended. The ground is relatively close, above its lower limit on the screen. The numerical indication 36 of the altimetric probe indicates a height above the ground of 2,130 feet.

In conclusion, it may be seen that the new display proposed makes it possible to show the pilot, in a very intuitive manner, the attitude of his aircraft.

The overall displaying of the pitch, roll and sideslip angles stems implicitly from the presentation of an aircraft 3D silhouette viewed from the rear and mobile in rotation about three axes while being specifiable by auxiliary numerical indications or markers.

Regardless of the nose-up or nose-down attitude of the aircraft, the precise value of its angle of inclination or roll is read on the side of the low wing of the aircraft 3D silhouette by situating the position of the index 8 or 8′ placed directly in line with this low wing with respect to the corresponding lateral inclination scale 6 or 6′ or else on a roll scale placed at the upper border of the image.

The pitch angle shown, in a rough manner by the attitude of the aircraft 3D silhouette, has its precise value given by a digital display that will compensate, in some cases, 4 for the absence of an explicit pitch angle scale.

The sideslip angle, which is never given in a precise manner by the onboard indicators, is easily assessed through the amount of lateral fuselage and of fin shown by the aircraft 3D silhouette.

The new display proposed also makes it possible for important additional information regarding other flight parameters of the aircraft relating to landing gear, flaps, airbrakes/spoilers, radio altimeter height, engine failures, engine fire and icing to be communicated to the pilot in a very intuitive manner.

The positions of the landing gear always appear, possibly in see-through mode, on the aircraft 3D silhouette displayed, thereby easily enabling the pilot to realize a poor position of one of the landing gear.

The position of the flaps with each segment displayed in white, well separated by a black line depicting a scale bar stands out sharply on the aircraft 3D silhouette displayed. To further improve the readability of the position of the flaps on the aircraft 3D silhouette displayed when a single flap notch is extended, the white surface shown for each extended flap segment may be bigger for the first segment than for the subsequent ones. The completely extended flaps appreciably modify the view of the aircraft 3D silhouette (FIG. 10). They make the crew aware of the modification of the dynamic profile effected, an important element within the framework of a fast reconfiguration of the aircraft in case of overshoot. The non-extending of a flap segment on account of failure is faithfully represented.

The airbrakes/spoilers are presented, by way of example, on the aircraft 3D silhouette displayed, by two corresponding segments with two possible angles of opening. The black and grey colors each represent angles of opening distinguishing them from the white color used for the flaps. It is possible, as for the flaps, to present other degrees of opening, the representation for the extending of the airbrakes in terms of number of segments represented being adapted to the characteristics of the aircraft modeled. The “ground” airbrakes open once the aircraft is taxiing (FIG. 10). In the presence of very considerable sideslip, airbrakes/spoilers may be masked and not appear on the aircraft 3D silhouette displayed. They are then, either viewed in see-through mode, or translated slightly toward the outer part of the wing in such a way that a significant amount of their surface is visible so as to continue to show their states of opening despite the tendency to masking.

On the display device, the ground rises up from a fixed position (out of radio altimeter range) until it touches the wheels. The scale of the representation of the position of the ground is not linear but accentuated for small heights. The digital value is always displayed as long as this information is available, either in black on a sky background, or in white on a ground background. When the ground rises up and the aircraft is inclined, the low wing is superimposed on a ground background as on a conventional display device of an ADI attitude indicator where the model airplane is superimposed on the sky or ground background.

Engine failure is depicted by a cross through the engine affected and clearly revealing to the crew that the engine concerned is unavailable. The failure information is related to a loss of power detected by the onboard equipment (of type N1 or Torque for turboprops). For engines situated against the fuselage at the rear, the critical view for showing the engines on the aircraft 3D silhouette displayed is that of a considerable sideslip where one of the engines may be partially masked. However, this masking is never total and the cross can always be placed on the engine affected. In the case of engines placed under the wings, there is no attitude that can mask them on the aircraft 3D silhouette displayed. When the nose of the aircraft is pulled up, the wing masks the rear of the engines but their front appears fore of the leading edges of the wings. In any event, in case of masking of an engine deemed excessive on the aircraft 3D silhouette displayed, it is always possible to reveal the engine concerned in see-through mode. For the cross showing the unavailability of an engine, the color red is preferred to the color black so as to comply with the color code for information classed WARNING.

An engine fire is indicated by the representation of smoke escaping from the affected engine. For a nose-up or nose-down trim, the smoke is symbolized by a fan of wavy lines placed directly in line with the engine concerned, in the direction of the flow of the air (FIG. 7). For a trim of close to zero degrees of pitch, the symbolization of the smoke is a trail deviating toward the part opposite the fuselage. The color red is preferred to the color black so as to comply with the color for information classed WARNING. The displaying of smoke persists as long as the smoke detection alarm is active. The simultaneous occurrence of the symbolization of engine fire and of engine failure is possible. Once the fire is under control, only the symbolization of the engine failure persists.

When the aircraft presents a sufficient nose-up trim for the leading edges of its wings to appear on the aircraft 3D silhouette displayed, icing is portrayed, on this aircraft 3D silhouette displayed, by a modification of the representation of the leading edges (FIG. 8), for example by a red coloration thereof, the hue of which is all the more intense the more considerable the icing phenomenon. For attitudes where the leading edges of the wings of the aircraft are masked on the aircraft 3D silhouette displayed, ice is represented by a highlighting of the upper surface of the wings (FIG. 6). There is no incompatibility between the two representations since the ice layer may go beyond contamination of just the leading edges of the wings. The color red is preferred like for the fire or engine failure. Should the airbrakes/spoilers be extended, the portrayal of ice at their level is removed so as to allow proper identification of their extension (FIG. 6). As indicated previously, when the onboard sensors of the aircraft measure the extent of the icing, this is conveyed, at the level of the aircraft 3D silhouette displayed, by a representation of the ice that is proportional to the thickness of frost measured, for example, for a nose-up trim (FIG. 8), by a highlighting of the leading edge of the wings progressing toward the rear of the wings proportionally to the thickness of frost measured on the wing or for a nose-down trim or a small pitch angle (FIG. 6), by a highlighting of the wings having a thickness proportional to the layer of frost measured on the wings.

The flight detector is symbolized by a circle for small or zero angles of pitch into which the pilot must inlay the aircraft 3D silhouette displayed, by appropriate maneuvers of his aircraft. For aircraft having an airframe of pronounced oval shape when viewed from the rear (Beluga type) leading to a modeling by an aircraft 3D silhouette displayed with an airframe of likewise pronounced oval shape that does not easily lend itself to such an inlaying operation, it is possible either to accompanying the aircraft silhouette displayed with a reference circle which follows it in all its rotational movements and which replaces it for the operations of inlaying into the circle of the flight director, or to deform the circle of the flight director so that it approaches the oval shape of the aircraft 3D silhouette displayed. For significant pitch angles, the flight director is symbolized by an arc of a circle with concavity pointing upward or downward according to a nose-down or nose-up preset respectively, the following of the preset involving the inlaying of the nose of the aircraft 3D silhouette displayed into the arc of a circle by appropriate maneuvers of the aircraft.

When the preset of the flight director involves a modification of the roll angle, it is conveyed, with respect to the aircraft 3D silhouette displayed, by a lateral movement of the circle or of the arc of a circle of the flight director preset. In case of sideslip or skid in the case of an unmodified trajectory, the preset of the flight director must coincide with the shape of the side-slipping aircraft so that only an action with the foot correcting the sideslip is required of the pilot. FIG. 5 shows a sideslip with the flight director still centered on the aircraft requiring only a correction on the yaw axis.

1. An aircraft attitude indicator receiving, from equipment aboard the aircraft, information on the aircraft flight conditions including measurements of the roll, pitch and yaw attitude angles of said aircraft with respect to a ground datum, comprising;
a display device producing on a screen, an image representing on a screen background, a three-dimensional aircraft silhouette, the screen background being split into two zones: a lower zone symbolizing the ground and an upper zone symbolizing the sky which are separated by a horizontal boundary line symbolizing the horizon line, and the aircraft silhouette being mobile according to the three axes of rotation and viewed from the rear, according to attitude angles which correspond to the attitude angle measurements received and which are referenced with respect to an aircraft datum having a roll axis perpendicular to the surface of the screen and pitch and yaw axes in the plane of the screen, one, the pitch axis, being horizontal and the other, the yaw axis, vertical, wherein the horizon line displayed moves heightwise over the screen as a function of the height of the aircraft with respect to the ground, as measured by the equipment aboard the aircraft.

2. The attitude indicator as claimed in claim 1, wherein said display device produces, on a screen background, an aircraft 3D silhouette exhibiting a difference of hue between its belly and its back so as to differentiate the nose-up attitudes from the nose-down attitudes.

3. The attitude indicator as claimed in claim 1, wherein said display device produces, on a screen background, an aircraft 3D silhouette resembling the type of aircraft that is intended to be equipped therewith.

4. The attitude indicator as claimed in claim 1, wherein said display device produces a screen background split into two zones: one of which symbolizes the sky and is blue in color.

5. The attitude indicator as claimed in claim 1, wherein said display device produces a screen background split into two zones: one of which symbolizes the earth and is brown in color.

6. The attitude indicator as claimed in claim 1, wherein said display device produces a screen background split into two zones: one of which symbolizes the earth and is green in color.

7. The attitude indicator as claimed in claim 1, wherein said display device produces an image representing, on a screen background, an aircraft 3D silhouette comprising parts changing aspect as a function of the momentary state of the corresponding part of the aircraft.

8. The attitude indicator as claimed in claim 7, wherein said parts changing aspect comprise movable elements depicting movable aerodynamic planes of the aircraft equipped with the attitude indicator, placed in positions corresponding to position indications provided by equipment aboard the aircraft.

9. The attitude indicator as claimed in claim 8, wherein said parts changing aspect comprise movable elements depicting the flaps of the aircraft equipped with the attitude indicator, placed in positions corresponding to flap position indications provided by equipment aboard the aircraft.

10. The attitude indicator as claimed in claim 9, wherein the movable depicting the flaps of the aircraft equipped with the attitude indicator are bar scales exhibiting as many bars as flap notches extended.

11. The attitude indicator as claimed in claim 8, wherein the movable elements depicting the airbrakes of the aircraft equipped with the attitude indicator, placed in positions corresponding to airbrake/spoiler position indications provided by equipment aboard the aircraft.

12. The attitude indicator as claimed in claim 11, wherein the movable elements depicting the airbrakes/spoiler of the aircraft equipped with the attitude indicator are bar scales exhibiting as many bars as airbrake notches extended.

13. The attitude indicator as claimed in claim 7, wherein said parts changing aspect comprise movable elements depicting the landing gear of the aircraft equipped with the attitude indicator, placed in positions corresponding to landing gear position indications provided by equipment aboard the aircraft.

14. The attitude indicator as claimed in claim 1, wherein said parts changing aspect comprise movable elements depicting the landing gear of the aircraft equipped with the attitude indicator, placed in positions corresponding to landing gear position indications provided by equipment aboard the aircraft.

15. The attitude indicator as claimed in claim 1, wherein said display device produces on a screen background in addition to an aircraft 3D silhouette, alignment symbols, corresponding to attitude presets for the aircraft.

16. The attitude indicator as claimed in claim 15, wherein said display device produces an image representing, on a screen background in addition to an aircraft 3D silhouette, an alignment symbol of circular shape, with the diameter of the aircraft 3D silhouette, and into which the pilot must inlay the fuselace or the tail of the aircraft 3D silhouette so as to comply with the corresponding attitude preset.

17. The attitude indicator as claimed in claim 15, wherein said display device produces an image representing, on a screen background, in addition to an aircraft 3D silhouette, an alignment symbol in the shape of an arc of a circle, with the concavity pointing toward the nose of the aircraft 3D silhouette, into which the pilot must bring the nose of the aircraft 3D silhouette so as to comply with the corresponding attitude preset.

18. The attitude indicator as claimed in claim 1, wherein said display device produces an image representing, on a screen background, an aircraft 3D silhouette with leading edges whose aspects differ as a function of the extent of the icing noted by equipment aboard the aircraft.

19. The attitude indicator as claimed in claim 18, wherein said display device produces an image representing, on a screen background, an aircraft 3D silhouette with leading edges having contours enhanced and overlaid as a function of the extent of the deposition of ice noted by equipment aboard the aircraft.

20. The attitude indicator as claimed in claim 19, wherein said display device produces an image representing, on a screen background, an aircraft 3D silhouette with leading edges having contours enhanced and overlaid in red or yellow, as a function of the extent of the deposition of ice noted by equipment aboard the aircraft.

21. The attitude indicator as claimed in claim 1, wherein said display device produces an image representing, on a screen background, an aircraft 3D silhouette with engines whose aspects differ as a function of their operating states.

22. The attitude indicator as claimed in claim 21, wherein said display device produces an image representing, on a screen background, an aircraft 3D silhouette with engines struck through with a cross in case of loss of power noted by equipment aboard the aircraft.

23. The attitude indicator as claimed in claim 22, wherein said display device produces an image representing, on a screen background, an aircraft 3D silhouette with engines struck through with a red or yellow cross (34) in case of loss of power noted by equipment aboard the aircraft.

24. The attitude indicator as claimed in claim 21, wherein said display device produces an image representing, on a screen background, an aircraft 3D silhouette with engines followed by a plume in case of detection of fire made by equipment aboard the aircraft.

25. The attitude indicator as claimed in claim 24, wherein said display device produces an image representing, on a screen background, an aircraft 3D silhouette with engines followed by a plume symbolized by a fan of lines in case of detection of fire made by equipment aboard the aircraft.

26. The attitude indicator as claimed in claim 24, wherein said display device produces an image representing, on a screen background, an aircraft 3D silhouette with engines followed by a plume symbolized by a fan of red lines in case of detection of fire made by equipment aboard the aircraft.

27. The attitude indicator as claimed in claim 1, wherein said display device produces an image representing, on a screen background, an aircraft 3D silhouette and numeral inlays corresponding to values of flight parameters.

28. The attitude indicator as claimed in claim 27, wherein said display device produces an image representing, on a screen background, an aircraft 3D silhouette and numeral inlays corresponding to the height of the aircraft above the ground as measured by equipment of the aircraft.

29. The attitude indicator as claimed in claim 28, wherein said display device produces an image representing, on a screen background, an aircraft 3D silhouette with numeral inlays corresponding to the height of the aircraft above the ground as measured by equipment of the aircraft, it vertically enframes these numeral inlays (36) with two elevation arrows showing that a measurement of vertical distance with respect to the ground is involved.

30. The attitude indicator as claimed in claim 15, wherein said display device produces an image representing, on a screen background, in addition to an aircraft 3D silhouette, an alignment symbol corresponding to an attitude preset for the aircraft, it also produces two numeral inlays, one corresponding to the angle of pitch corresponding to the attitude preset and the other to the measured angle of pitch.

31. The attitude indicator as claimed in claim 15, wherein said display device produces an image representing, on a screen background, in addition to an aircraft 3D silhouette, an alignment symbol in the form of two strokes against which the pilot must bring the leading edge of the wings of the aircraft silhouette so as to comply with the corresponding attitude preset.

32. The attitude indicator as claimed in claim 21, wherein said display device produces an image representing, on a screen background, an aircraft 3D silhouette, with engines colored yellow or amber in case of loss of power noted by equipment aboard the aircraft.

33. The attitude indicator as claimed in claim 21, wherein said display device produces an image representing, on a screen background, an aircraft 3D silhouette, with engines colored red and followed by a plume in case of detection of fire made by equipment aboard the aircraft.

34. The attitude indicator as claimed in claim 1, wherein said display device produces at the image boarder, at least one scale graduated in terms of angle of pitch and a movable marker moving opposite same indicating the graduation value corresponding to the pitch angle measurement provided by the equipment aboard the aircraft.

35. The attitude indicator as claimed in claim 34, wherein said display device produces, at the image lateral borders, two scales graduated in terms of angle of pitch and movable markers moving opposite same indicting the graduation value corresponding to the pitch angle measurement provided by the equipment aboard the aircraft.

36. The attitude indicator as claimed in claim 34, wherein said display device produces, at the image upper border, a scale graduated in terms of angle of roll and a movable marker moving opposite same indicting the graduation value corresponding to the roll angle measurement provided by the equipment aboard the aircraft.
